(19) United States
(12) Patent Application Publication
(10) Pub. No.: US 2002/0093528 A1
(43) Pub. Date: Jul. 18, 2002

(54) User interface for managing intellectual property

(75) Inventor: Jeffry J. Grainger, Portola Valley, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: First to File, Inc., Menlo Park, CA (US)

(21) Appl. No.: 09/919,764

(22) Filed: Jul. 31, 2001

Related U.S. Application Data
(60) Provisional application No. 60/253,360, filed on Nov. 27, 2000.

(51) Int. Cl. G09G 5/00

(52) U.S. Cl. 345/738

(57) ABSTRACT

A computer graphical user interface that provides access to information stored on a computer-readable medium that pertains to a selected patent application. In one embodiment the graphical user interface includes at least first, second and third display sections. In this embodiment, the first display section displays a plurality of first file links selectable by a user of the user interface, each of the first file links providing access to correspondence generated from one or more of an inventor client system, an in-house client system or an outside representative client system; the second display section displays a plurality of second the links also selectable by the user with each of the second file links providing access to a patent document that was filed in or sent from a patent office and that is stored on the computer-readable medium in an image file format; and the third display section displays a plurality of third file links selectable by the user with each of the third file links providing access to a patent file that is associated with an application program and stored on the computer-readable medium in a format native to said associated application program.

### CROSS-REFERENCES TO RELATED APPLICATIONS

This application claims priority to U.S. Provisional Application No. 60/253,360, entitled DATA PROCESSING SYSTEM FOR MANAGING INTELLECTUAL PROPERTY, filed on Nov. 27, 2000 and listing Jeffry J. Grainger as inventor. The disclosure of U.S. Ser. No. 60/253,360 is hereby incorporated herein by reference in its entirety.

### STATEMENT AS TO RIGHTS TO INVENTIONS MADE UNDER FEDERALLY SPONSORED RESEARCH OR DEVELOPMENT

Not Applicable

### REFERENCE TO A “SEQUENCE LISTING,” A TABLE, OR A COMPUTER PROGRAM LISTING APPENDIX SUBMITTED ON A COMPACT DISK

Not Applicable

### BACKGROUND OF THE INVENTION

The present invention relates to managing intellectual property. More particularly, embodiments of the invention relate to a graphical user interface used to access documents and other information that is stored electronically and associated with a selected patent application.

As the world economy has become more information and technology oriented, patents and other intellectual property are of growing importance. In order to secure such intellectual property rights appropriate paperwork needs to be completed and filed in an intellectual property office. For example, in order to secure patent protection within the United States, a patent application describing and claiming an invention needs to be filed in the United States Patent and Trademark Office (hereinafter “USPTO”). Once filed, previously established rules and guidelines are followed by a Patent Examiner to determine whether or not patent rights to the invention should be granted. Typically, the process for obtaining these rights includes communications between the patentee and the patent office with many of such communications requiring a response within a given time period.

FIG. 1 is a diagram that illustrates a typical sequence of events and exchanges that occur between technology developers 2 and a Patent Office 6, such as the USPTO, in order to secure protection for a patent application. Also shown in FIG. 1 are patent attorneys and/or patent agents 4 (hereinafter referred to collectively as “patent attorneys”) that often represent technology developers 2 in patent procurement process along with their administrators. As used herein, technology developers are inventors, corporations and other entities that generate inventions and other ideas to be turned into patent applications (i.e., the intellectual property creators). Also, a “patent office” is any patent office designated to receive patent filings for an individual country or collection of countries as provided for by various treaties or other compacts that countries may enter. Examples of patent offices include but are not limited to the United States Patent and Trademark Office, the European Patent Office, the German Patent Office, the Japanese Patent Office and any designated receiving office for patent applications filed under the Patent Cooperation Treaty.

As shown in FIG. 1, the patent process typically starts with the communication of an idea (invention) from a technology developer 2 (sometimes referred herein to as “Applicant”) to a patent attorney 4. Such an idea is often communicated to patent attorney 4 in the form of a written invention disclosure 10. The patent attorney then prepares a patent application 12 that is filed in the USPTO. After the application is received by the USPTO and it is verified that all the necessary papers have been correctly completed, the application is examined by a qualified patent examiner (hereinafter the “Examiner”). The Examiner then prepares and sends an Office Action 14 to patent attorney 4. The Office Action sets forth the USPTO's initial opinion on the patentability of the invention (of course, other papers, such as a Restriction Requirement or Notice of Allowance, may be prepared and sent instead of an Office Action as appropriate).

Patent attorney 4 reports receipt of the Office Action to technology developer 2 by sending a Notification 16 that often summarizes key issues in the Office Action. In some instances, Applicant then prepares Instructions 18 to patent attorney 4 so that the attorney may prepare and file an appropriate Response 20. This Office Action 14/Response 20 cycle may be repeated one or more times until the Examiner mails a Notice of Allowance 22 to patent attorney 4 indicating the patent application is in condition for allowance or the case is abandoned. If allowed, patent attorney 4 mails a Notification 24 of the Allowance to Applicant 2 who provides Instructions 26 to patent attorney 4 to transmit the Issue Fee 28 to the Patent Office. Several months after the Issue Fee is paid an Issued Patent 30 is published. U.S. Patent Law requires Maintenance Fees to be paid on an issued patent 3½, 7½ and 11½ years after issuance to maintain the patent in force. Attorneys 4 typically send Fee Reminders 32 to Applicants 2 about such maintenance fees. Applicants respond with Instructions 34 to ensure that Fees 36 are paid in a timely fashion.

FIG. 1 is just a brief overview of the patent process, however. In many instances there are numerous other communications and exchanges between the inventor and attorney, between the in-house attorney and outside attorney and between a foreign attorney or agent and prosecuting attorney or agent that are not shown in FIG. 1. Also, the communications shown in FIG. 1 pertain to obtaining patent protection in a single country. As can be appreciated, obtaining protection for a patent application in multiple countries, i.e., prosecuting the application to issuance and paying necessary annuity and maintenance fees, involves many more communications between applicants, patent attorney 4 and the Patent Office and may also include communications between an additional patent attorney 4 that specializes in patent protection for the particular country. Accordingly, there may be well over a hundred separate communications/transactions between the applicant or inventor, attorneys and/or patent agents and the various patent offices for a single patent application.

Accurately tracking all the various communications and papers associated with a patent filing so that, when needed, such communications and papers can be retrieved in a timely manner is an important aspect of managing an intellectual property portfolio. Typically, patent filers keep paper-based files, one for each patent application in each individual country that protection is sought, that store and organize all such communications and papers. Law firms and corporations have devised a number of different approaches for organizing such files. For example, some law firms use trifold files and keep communications between the client and attorney on the left side of a folder, papers filed in or received from the Patent Office in the center portion of the file and miscellaneous other papers (e.g., copies of the application as filed and/or figures) on the right side of the file. While such file organization methods have served well in the past, it is desirable in some instances to do away altogether with paper-based files and move to a more electronic or “paperless” approach. Accordingly, a graphical user interface that enables a user to quickly and efficiently access documents and other information stored electronically and associated with a selected patent application is desirable.

### BRIEF SUMMARY OF THE INVENTION

Embodiments of the present invention provide a graphical user interface that provides quick and easy access to the various communications and documents associated with a patent application.

According to one embodiment, a computer graphical user interface that provides access to information stored on a computer-readable medium that pertains to a selected patent application is disclosed. The graphical user interface includes at least first and second display sections with each of the display sections including a plurality of file links selectable by a user of the user interface. File links in the first display section provide access to patent documents that were filed in or sent from a patent office and that are stored on the computer-readable medium in an image file format, and file links in the second display section provide access to patent files that are associated with an application program and stored on the computer-readable medium in a format native to said associated application program. Some embodiments include at least a third display section that has file links which provide access to correspondence generated from one or more of an inventor client system, an in-house client system or an outside representative client system. In some embodiments at least some of the patent files accessible through the third section correspond to patent documents accessible through the second section. In still further embodiments the three display sections are displayed immediately adjacent to each other on a display. Still other embodiments include a fourth display section that displays or provides access to information including the title of the patent application, the application's filing date, the application number and the list of inventors.

According to another embodiment, a computer-implemented method of providing access to information pertaining to a patent application is disclosed. This method includes storing the information on a computer-readable medium accessible to a server system, wherein the information includes at least (i) correspondence generated from one or more of an inventor client system, an in-house client system and an outside representative client system; (ii) patent documents filed in or sent from a patent office; and (iii) patent files associated with the patent application. At least some of the patent documents are stored in an image file format and at least some of the patent files are associated with an application program. The method also includes generating, from the server system, a web page that includes at least first, second and third separate sections with the first section including links to the correspondence, the second section including links to the patent documents and the third section including links to the patent files. In some embodiments, the web page is then viewable from a client system over the Internet.

These and additional embodiments of the present invention, as well as its advantages and features, are described in more detail in conjunction with the text below and attached figures.

### BRIEF DESCRIPTION OF THE DRAWINGS

FIG. 1 is a diagram that illustrates a typical sequence of events involved in filing a patent application in an Patent Office, such as the United States Patent and Trademark Office;

FIG. 2 is a simplified block diagram showing the relationship between an intellectual property data processing system 100 according to one embodiment of the present invention and participants in the patent process;

FIGS. 3A-3C are exemplary Web pages generated by IP data processing system 100 according to one embodiment of the present invention;

FIG. 4 is an exemplary Web page that illustrates one embodiment of a trifold graphical user interface according to the present invention;

FIGS. 5-7 are additional exemplary Web pages generated by IP data processing system 100 according to certain embodiments of the invention; and

FIG. 8 is an exemplary Web page interface used to retrieve patent status information from the USPTO.

### DETAILED DESCRIPTION OF THE INVENTION

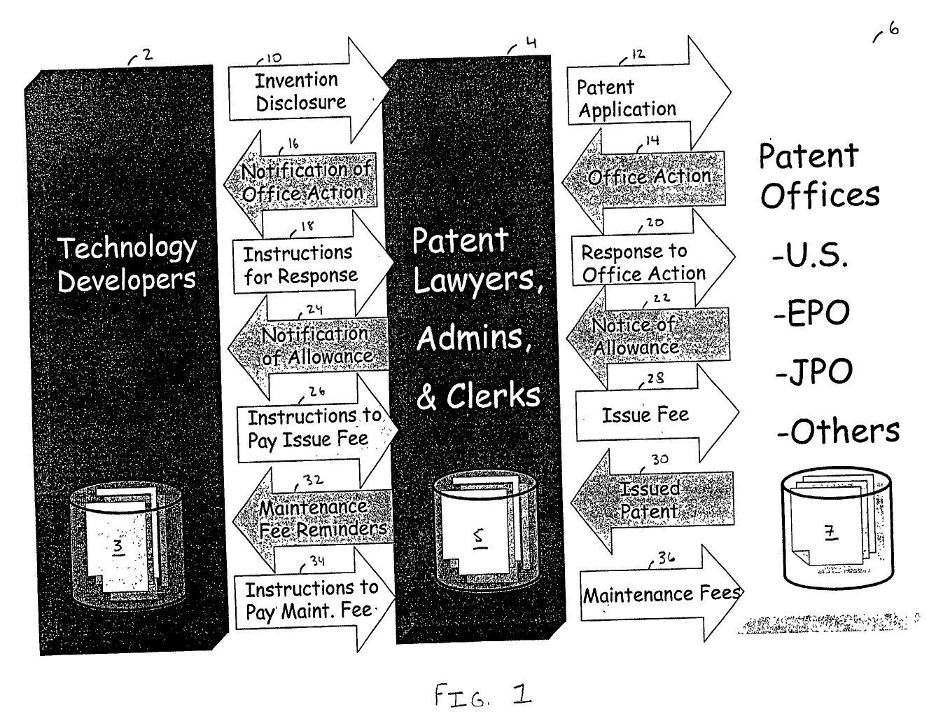

The present invention provides a novel and useful interface that provides quick and easy access to the various communications and documents associated with a patent application. The interface can be generated from, among other possibilities, a computer program that executes on a stand-alone computer or a computer server in a distributed computer network. For convenience, the description of one embodiment of the interface is set forth below with respect to an application service provider (ASP) model that communicates with client systems over the Internet. In this ASP model, an intellectual property data processing system 100 converts the paper-based patent prosecution system described with respect to FIG. 1 into an electronic workflow pipeline that allows every step in the process to be executed from a computer desktop. One of ordinary skill in the art would recognize other variations, modifications and alternatives to this embodiment. Accordingly, the ASP system described below is not intended to limit the scope of the invention in any way.

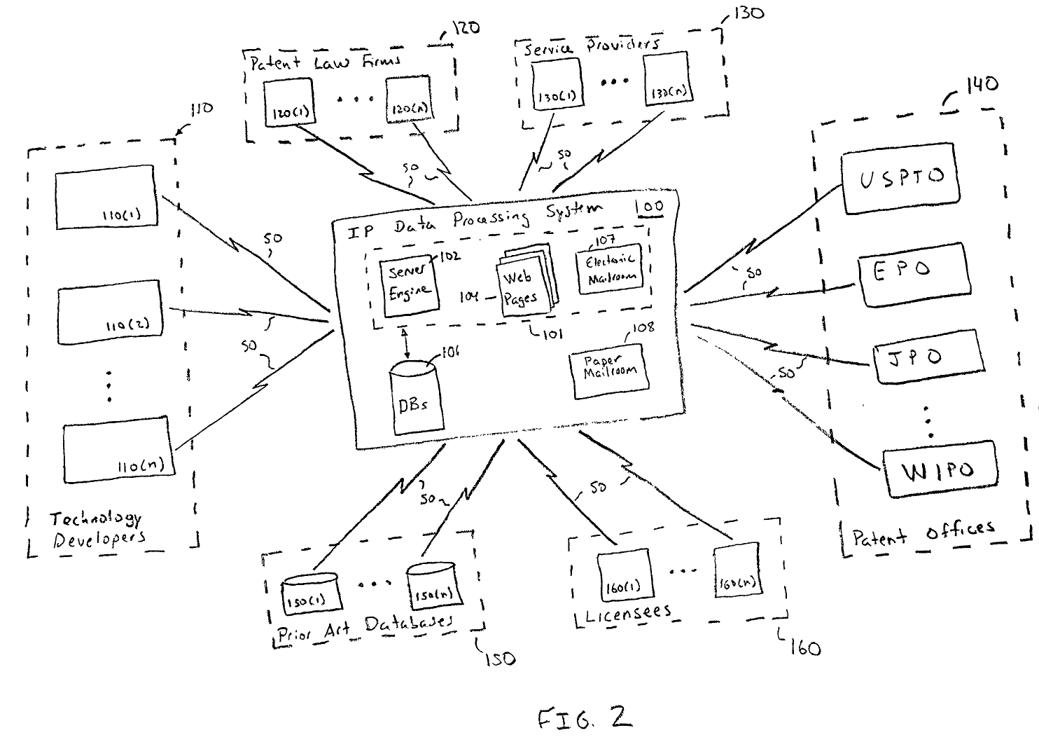

FIG. 2 is a simplified block diagram showing the relationship between an intellectual property (IP) data processing system 100 according to one embodiment of the present invention and participants in the patent process. IP data processing system 100 is a Web-enabled electronic platform that can be utilized by all participants in the patent process.

The participants shown in FIG. 2 include technology developers 110, patent law firms 120, service providers 130, patent offices 140, prior art databases 150 and potential licensees 160. For convenience, each of these participants is referenced by a dotted line that encompasses individual entities of the participant type. For example, technology developers 110 are shown in FIG. 2 as including individual technology developers 110(1), 110(2) through 110(n). It is to be understood that, while shown in FIG. 2 as a group, these multiple technology developers are separate entities that likely have no relation to each other than their classification within this patent application as developers of technology. It is also to be understood that, while not shown, each individual participant system typically includes its own firewall system that implements access control functions to isolate the system from unwanted intrusions by others.

Each of the participants shown in FIG. 1 can communicate and exchange information through Internet 50. A person of ordinary skill in the art would recognize that in other embodiments the participants may communicate and exchange information using other communication network mediums including a local or wide area network (LAN or WAN), a wireless network, an intranet, a virtual private network and the like.

Technology developers 110 include corporations, universities and individual inventors seeking to file patent applications and receive issued patents. Patent law firms 120 include U.S. patent attorneys, patent agents and foreign patent attorneys and/or agents. Service providers 130 include patent draftsman, prior art search companies, translation companies and other entities that provide services useful to the patent process as well as financial institutions and other parties that have tangential roles in the process. Prior art databases 150 include public and licensed private databases, such as online patent databases (e.g., issued U.S. patents, published European and Japanese patents, etc.) and non-patent databases. Patent offices 140 include patent offices worldwide including the USPTO, the European Patent Office (EPO), the Japanese Patent Office (JPO), the Taiwanese Patent Office, etc.

Processing system 100 provides technology developers 110 and their associated patent law firms 120 a highly secure, central data repository that can be shared between participants on an as-allowed basis. Information generated and used during the patent prosecution process can be shared between a technology developer 110 and appropriate patent law firm(s) 120 and service provider(s) 130 in order to create patent filings, prosecute such filings through issuance and then subsequently maintain patent rights after grant.

As shown in FIG. 2, IP data processing system 100 includes a Web server 101, a database 106 and paper mailroom 108. Web server 101 includes a server engine 102 that generates and sends graphical documents including Web pages 104 to client systems as requested and an electronic mailroom 107. As used herein, a “client system” is a computer system that displays Web pages generated by server engine 102, e.g., through a browser residing on the client system. Thus, technology developers 110, patent law firms 120, service providers 130 and licensees 160 typically include one or more client systems. For example, a large corporation (technology developer) may have 150 inventors, 4 patent administrators and 2 in-house patent attorneys. Each of these individuals likely has their own computer system and can thus become a client system. Specific categories of client systems are also sometimes referred to herein. For example, an “inventor client system” is any client system associated with an inventor from one of the technology developers 110. Similarly, an “in-house client system” is any client system associated with a patent attorney, patent agent, patent administrator, secretary or other employee or contractor of a technology developer other than an inventor that has rights to create, edit or view information related to patent applications owned by the technology developer. An “outside representative client system” is an outside patent attorney, patent agent, patent administrator, secretary or other employee or contractor associated with a patent law firm 120 that represents a particular technology developer.

Each client system can display the Web pages generated by server engine 102. Each of such Web pages is uniquely identifiable by a Uniform Resource Locator (URL) and is stored in a computer-readable memory (not shown) accessible to the server engine. To view a specific document, including a Web page, a client system uses a Web browser executing on the client system to specify the URL for the document in a request (e.g., a HyperText Transfer Protocol “HTTP” request) as is known to those of skill in the art. The request is forwarded to the Web server supporting the document (server system 101 in this instance), which when it receives the request, sends the requested document to the client system. The Web browser may then display a Web page contained in the document, e.g., HTML document.

Database 106 stores information pertaining to the technology developers' intellectual property portfolios. Patent process participants (such as technology developer employees and outside law firm personnel) access this information as needed and only to extent that their access rights permit. The information in database 106 includes draft and completed invention disclosures, draft and completed patent application documents; draft and completed amendments; messages and discussions pertaining to invention disclosures and patent applications; patent and patent application status information; prior art publications; office actions, assignment papers and other forms and papers filed in or generated by a patent office; etc. As described in detail below, much of this information for an individual patent application is easily accessible to a user through the user interface of the present invention.

IP data processing system 100 communicates with patent offices 140 over Internet 50 through electronic mailroom 107 and through standard snail mail (e.g., U.S. Postal Office Express Mail) using paper mailroom 108. For such communications in some embodiments, system 100 sets the correspondence address to mailroom 107 or 108 so that replies to the communications can be tracked and entered into database 106 as described below.

Electronic mailroom 107 is part of server 102 and includes a suite of programs that interface to the standards set by each patent office 140. For example, in order to file patent applications electronically through the USPTO the system comports to the standards required by the USPTO's Electronic Filing System (EFS). This includes using the Electronic Packaging and Validation Engine (ePAVE) or compatible software to facilitate electronic filing. Complete details of the ePAVE software are available online through the USPTO's Electronic Business Center Web site at http://pto-ebc.uspto.gov/. Also, in order to track and update status information for pending patent applications, such as Examiner name, assigned art unit and class/subclass, etc., electronic mailroom 107 has the ability to interface to the USPTO's Patent Application Information Retrieval (PAIR) system using appropriate digital certificates. Electronic mailroom 107 also includes other programs to interface with other patent offices.

Paper mailroom 108 includes printers, fax machines and other appropriate equipment to carry out all the duties necessary to file patent applications and other formal papers in patent offices using standard mailing procedures. Paper mailroom 108 also includes scanners and equipment necessary to scan papers received from technology developers 110, patent attorneys 120 and patent offices 140 into computer-readable format. Such correspondence is scanned and analyzed by optical character recognition (OCR) software to create two versions of the document: an image version and a text version created by the OCR software. The image version is stored for archival purposes. The OCR software is calibrated to recognize particular fields within common patent office forms to capture data from those forms so that appropriate data (e.g., due dates, Examiner's name, Applicant, application no., etc.) from such papers can be parsed and entered into database 106. To this end, the fields of various patent office forms that are scanned by mailroom 108 are mapped to database 106 along with the document type (determined from the form recognition sequence) in order to enable the system to determine the appropriate docketing deadlines. Alternatively, or in addition to such scanning, personnel in mailroom 108 can directly enter appropriate data into database 106 using computers or data entry terminals coupled to the database through a local area network or similar network. Once scanned into computer-readable format, communication between IP data processing system 100 and technology developers 1 10 can proceed in a manner that, from the standpoint of a technology developer, seems entirely paperless.

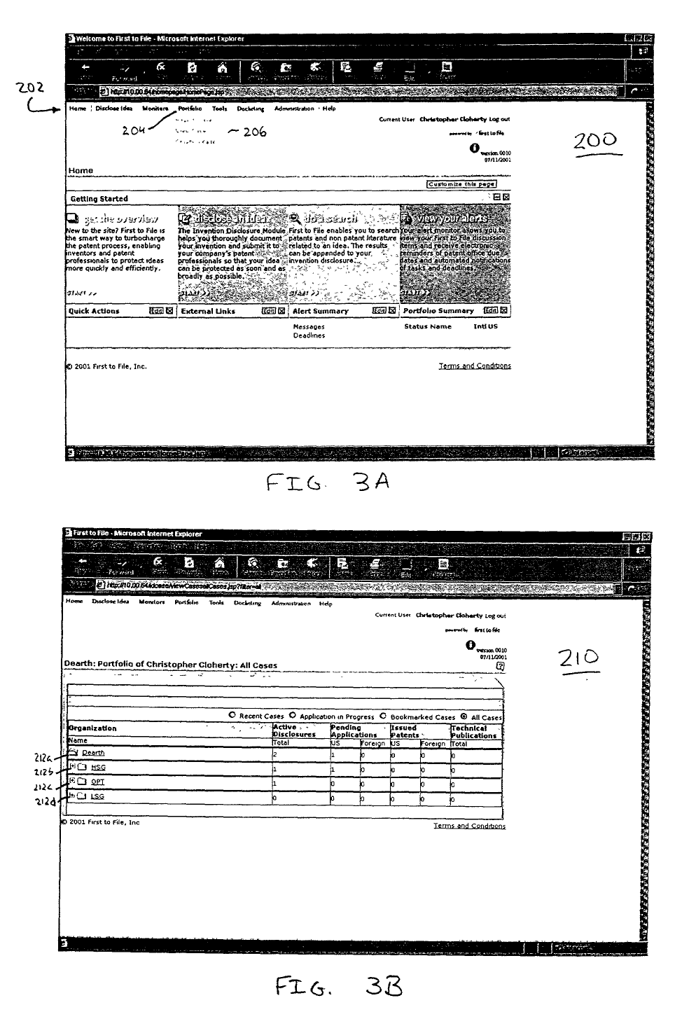

FIG. 3A is an example of a Web page 200 that may be the home page for an outside representative client system at a patent law firm 120(i) or for an in-house client system at a technology developer 110(i) among other client systems. Web page 200 provides appropriate client systems with quick access to reporting capabilities that enable a “big picture” view of a company's or client's IP assets. As shown in FIG. 3, one such reporting capability is accessible through a navigation menu 202 by selecting a “view cases” menu selection 206 under a portfolio entry 204 in the menu bar.

Upon selecting the “view cases” menu selection 206, for example by double clicking on the selection, the client system is presented with a Web page 210 (FIG. 3B) that provides access to each patent application file the client system has access rights to view. Links labeled as file numbers and/or patent application titles to each patent application file may be directly accessible on page 210 or the links may indirectly accessible through other links, e.g., a package or a file folder. For example, if the viewing client system is an outside attorney, there may be a folder for each client the attorney represents with each client file folder containing one link to each patent application the attorney is responsible for that client. The client system viewing Web 210 in this example, however, is an in-house client system and, as shown in FIG. 3B, displayed on page 210 are four folders 212a-212d. Folder 212 a represents cases assigned to a particular outside fictional company, Dearth. Folders 212b-212d are actually folders within folder 212a and represent company divisions within Dearth. Folders such as folders 212a-212d may contain links (not shown in FIG. 3B) to the individual patent files of each division. FIG. 3C is an exemplary Web page 220 that shows links 222a and 222b to two individual patent files within the HSG (Health Solutions Group) group folder 212b shown in FIG. 3C.

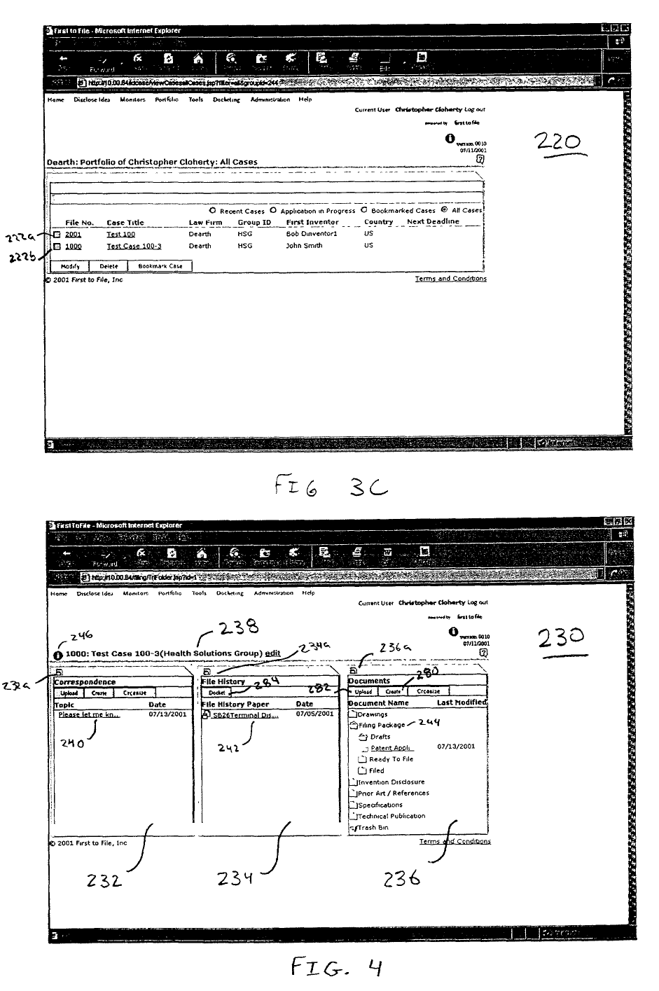

Each link 222a and 222b is selectable under either the unique file number associated with the patent file or by the patent file's title. Once selected, a graphical user interface according to the present invention is displayed that provides the client system quick and easy access to various communications and documents associated with the patent application. FIG. 4 shows an exemplary Web page 230 according to one embodiment of a trifold graphical user interface that provides the client system access to communications and documents associated with a patent application. Web page 230 emulates the look and feel of an actual trifold paper file that is used by some law firms and corporations to organize patent documents.

As shown in FIG. 4, there are four primary display sections on Web page 230. These include correspondence section 232, file history section 234, document section 236 and case summary section 238. Correspondence section 232 displays a list of all correspondence between the outside and in-house attorneys, patent administrators and inventors for the selected patent matter (“Test Case 100-3” of the “Health Solutions Group” in this particular example). Entry 240 in correspondence section 232 is an html link that leads to the underlying correspondence document. Thus, to view an individual correspondence document in section 232, the user of the client system simply selects the link associated with the desired correspondence document. Similarly, each of the documents shown in file history section 234 and document section 236 are also html links to underlying documents. Correspondence documents can be email messages, word processing documents, scanned image files as well as other types of documents. Rather than leading directly to the document in all cases, some of these links may represent a package, or collection of documents, and when selected a Web page is displayed that shows the contents of the package, i.e., the list of documents in the package.

A person of skill in the art will recognize that selection techniques other than html links may be used in other embodiments of the invention, for example, in some alternative embodiments, entry 240 and other document identifiers in sections 234 and 236 are filenames that can be selected to obtain the underlying document. As used herein, the term “file link” is used to generically represent something selectable by a user to access an underlying document either directly (e.g., if the file link is a selectable hypertext link to the document or a selectable document filename in a Windows or other computing environment) or indirectly (e.g., if the file link is a selectable hypertext link to a page displaying hypertext links to multiple, associated documents or a selectable folder or package in a Windows or other computer environment that contains one or more documents). Documents include email messages, files stored in image format, files stored in a format associated with an application (e.g., word processing files), forms, and the like.

File history section 234 lists all the official papers that have been sent to and received from the patent office. These documents (referred to as “patent documents” herein) are stored in an image format (e.g., .pdf, .bmp or .tiff file formats). The image format preserves the actual look of any paper documents that were either transmitted to a patent office in paper format or received from a patent office in paper format. The image format also prevents the documents from being accidentally modified or edited in most instances. In some embodiments, the patent documents in file history section 234 are also locked so that they cannot be edited or deleted by most users. As shown in FIG. 4, file history section 234 includes an html link 242 to an underlying Terminal Disclaimer paper that was filed in the Patent Office. Typically, section 234 would also include links to the filed patent application, declaration and oath papers and other documents—all stored in an image format. In some embodiments, only files stored in an image format are allowed to be displayed for access through section 234. Other embodiments, however, also allow for documents having other formats to be displayed in section 234. For example, an electronic filing receipt received from the USPTO in response to an electronic filing is typically received in an email message format. Such a “paper” is a document that was sent directly by a patent office and thus belongs in the file history section. While some embodiments will convert the document to an image format file for display in section 234, other embodiments will provide access to it in the format it was received through section 234.

Document section 236 lists files (referred to as “patent files” herein) associated with the selected patent application that were created by the applicant, the applicant's attorney or similar party. These patent files include documents such as invention disclosures that are not filed in a patent office as well as patent applications, responses to office actions and other documents that either were filed or are going to be filed in a patent office. Many of the patent files listed in document section 236 are stored in a format in which they are accessible, and editable if they are not locked, to the application program from which they were created or with which they are associated. Typically these files are stored in a format native to the associated application. For example, an invention disclosure, a patent application and a response to an office action that were all created by MS Word™ 2000 may all be stored in a .doc file. In other embodiments, however, it is possible to store these files in other formats such as text files (.txt) or compressed files (.zip) that are readily convertible to native file formats by the application program itself. For example, .txt files are readily convertible to .doc files by MS Word whereas a .pdf file of a scanned letter is not readily convertible to a .doc file since such a conversion requires optical character recognition (OCR) techniques.

Documents in section 236 may be organized in file folders. For example, one file folder 244 shown in FIG. 4 is entitled “filing package.” Filing package 244 may include a number of separate documents that are all part of a single patent filing, e.g., patent drawings associated with a drawing program such as Visio™, a patent specification associated with a word processor such as MS Word™ and various patent office forms, such as fee transmittal forms, information disclosure statement forms, etc. System 100 allows electronic access to both static and dynamic forms. Patent office forms may be stored in a variety of manners. For example, completed static forms may be stored in an image format (e.g., .pdf files) while for dynamic forms, the data associated with the form may be stored in a database. In the later case, when the user selects the form by clicking on its link to view the form, data processing system 100 can either generate the form for display to the user or display the data that is associated with fields of the form in some other format.

Case summary section 238 includes summary information about the particular patent application such as one or more of the invention's title, the list of inventors, the application filing date, the application number, list of countries the application was filed in, etc. In the embodiment illustrated in FIG. 4, a small subset of this information is displayed directly in section 238 (e.g., the title) and more detailed summary information can be accessed by selecting an information icon 246. Additionally, Web page 230 includes icons 232a, 234a and 236a that can be selected to display respective sections 232, 234 and 236 in a full page mode that displays more information than the approximately third of the screen each section takes up on page 230.

According to one embodiment, display sections 232, 234 and 236 each include multiple rows that each contain a file link to the correspondence, patent documents and patent files accessible through the sections. The sections may also contain multiple columns to display desired information. For example, a first column may contain an icon that indicates what type of document is associated with the file link (e.g., file folder or package, MS Word document, Visio document, email message, Web page, etc.), a second column may contain the file link, and a third column may include information such as the date a patent file was edited, the date a patent document or correspondence document was sent or received.

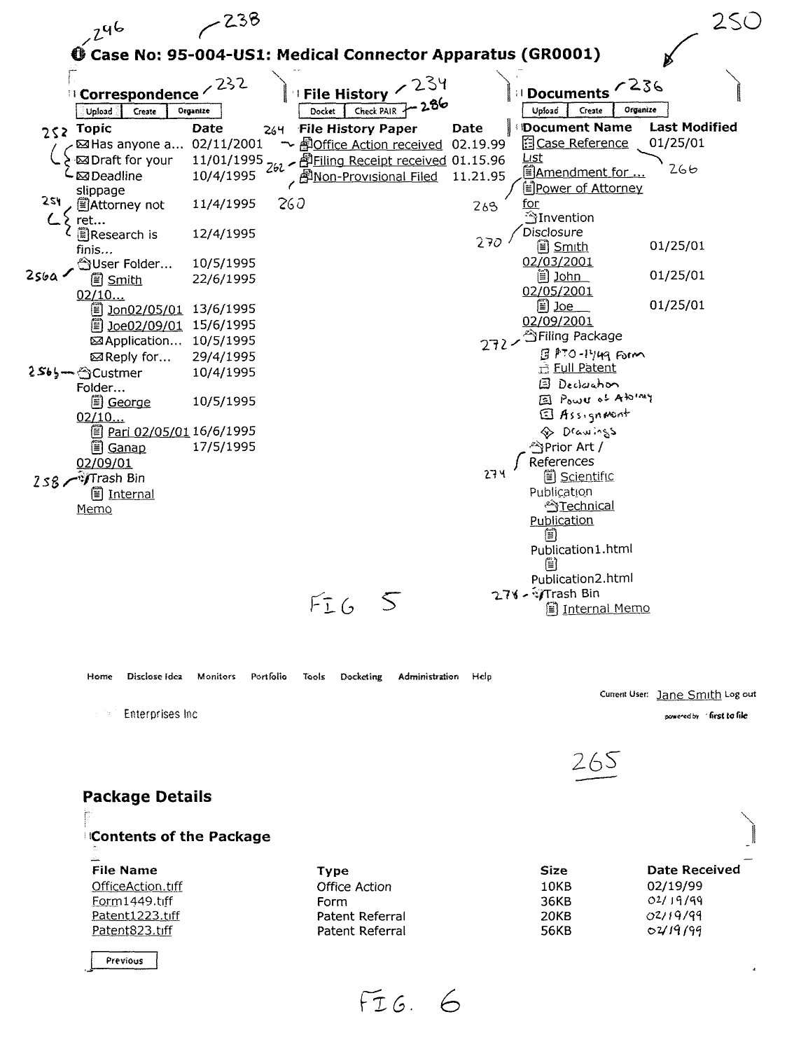

FIG. 5 is an example of a Web page 250 that shows another version of the trifold graphical user interface shown in FIG. 4 for a different data set. Note that while the format of trifold graphical user interface in FIG. 5 may seem different than that of FIG. 4 this is primarily due to different methods used to transfer the interface onto a printed page. As shown in FIG. 5, Web page 250 includes correspondence section 232, file history section 234, document section 236 and information section 238. Correspondence section 234 includes several email messages 252 and documents 254, e.g., MS Word™ files. It also includes folders 256a and 256b with each folder including additional documents. If desired, folders 256a and 256b can be created by a client system to organize and save documents, email messages, etc. that are related to a specific subject or issue that are pertinent only to certain client systems and thus are not viewable by others. For example, User Folder 256a may be user specific and include notes and emails the particular user desires to associate with the patent application for the user's records. Alternatively, folders can be created to organize and store documents and messages that are viewable by several different client systems as defined by the folder creator but not viewable to others who have access to other data of page 250. For example, a folder may organize documents viewable by all in-house client systems that have access to the patent application to track information related to an attorney working on the patent application that they may not want to share with either outside representative or inventor client systems. Section 232 also includes a trash bin 258 that stores deleted documents and messages until they are purged.

File history section 234 includes a patent application 260 and its associated documents that were filed in a patent office as well as a filing receipt 262 and first Office Action 264 that were received from the patent office. Each of the links 260, 262 and 264 actually represents a package of several documents with each individual document being stored in an image file format. Upon selecting the link, a Web page is displayed that shows the contents of the package and allows viewing access to the underlying documents. In this example, patent application package 260 was generated through IP data processing system 100 and filed electronically. Upon filing the application, an archived copy of each of the filed papers was created electronically in .pdf format and saved in section 234. Packages 262 and 264, on the other hand, were received at paper mailroom 108 and scanned into .pdf format. Once these documents were associated with case number 95-004-US1, links to the documents were automatically created for display in section 234. The lock displayed next to each of packages 260, 262 and 264 indicates that the documents contained in these packages are locked and therefore cannot be edited.

FIG. 6 is an example of a Web page 265 that shows the contents of office action package 264. As shown in FIG. 6, package 264 includes four different documents each stored in an image file format: a copy of the Office Action itself, a copy of a signed PTO-1449 form and copies of two different prior art patents that are referred to in the Office Action.

Document section 236 includes a list 266 of references cited in the case, an amendment 268 that is being prepared in response to the Office Action associated with link 264, a folder 270 that contains copies of several different versions of original invention disclosures for the patent application prepared by different inventors and a filing package folder 272 that contains documents filed in the patent office with the patent application. At least some of the documents in folder 272 correspond directly to the documents in patent application package 260. This is an important aspect of some embodiments of the invention. Both image format files and application format files for essentially the same document are accessible through different display sections of the interface. For example, as described above, if patent application package 260 includes the patent specification, the patent drawings, separate inventor oath and declaration forms, a power of attorney form, an assignment form and a transmittal form—each in an image file format, filing package folder 272 contains copies of these documents in their underlying native application format. That is, folder 272 contains a copy of the patent application in word processor format, a PTO-1449 form, separate declaration and power of attorney forms, an assignment form and patent drawings in either a format associated with a drawing program or a scanned format. Corresponding pairs of documents for responses to office actions and other papers created through system 100 and filed in a patent office will also exist between section 234 and 236 in other instances. Section 236 also includes a folder 274 that holds various prior art documents, e.g., the documents cited in the PTO-1449 form and a trash bin 276 that is similar to bin 258.

List of references 266 is a link to a Web page, such as page 280 shown in FIG. 7. Web page 280 displays all the references that are either believed to be or have already been identified as being relevant to the patent application. Page 280 includes information identifying the reference including a link to the underlying reference (e.g., link 282), a selection box 284 that indicates whether or not the reference has already been cited in an IDS or cited by the Examiner, and a selection box 286 that indicates whether or not the Examiner has acknowledged considering the reference during his or her examination of the patent application.

One feature provided in some embodiments of the present invention is that whenever an action is taken to create a document from the trifold graphical user interface, IP data processing system 100 automatically associates the created document with the patent application file shown on the trifold interface. For example, referring back to FIG. 4, document section 236 includes create and upload icons 280 and 282. Selecting upload icon 282 allows a client system to upload a document that was not originally created through IP data processing system 100 into the system. When the upload icon is selected from page 230, the uploaded document is automatically associated, e.g., in a database table, with Test Case 100-3 that trifold interface 230 provides access to. Similarly, create icon 280 allows the client system to initiate creation of a new document, such as a new patent application from an already filed invention disclosure or a new amendment after receiving an office action. When create icon 280 is selected, all fields that can be populated with data already in database 106 are so populated and the document is automatically associated with the case displayed in the user interface. The system will prompt the user for specific information for unpopulated fields or confirmation (and validation) of populated fields.

Other features provided in some embodiments are available by selecting a docket icon 284 in file history section 234. Upon selecting docket icon 264, a user may either create a case-specific docket entry or generate a report that shows all the upcoming due dates for various docketed events for the case being accessed through the graphical user interface. These due dates may include, for example, dates for filing a nonprovisional application, filing foreign patent applications, filing responses to office actions, paying annuity fees, paying maintenance fees, etc.

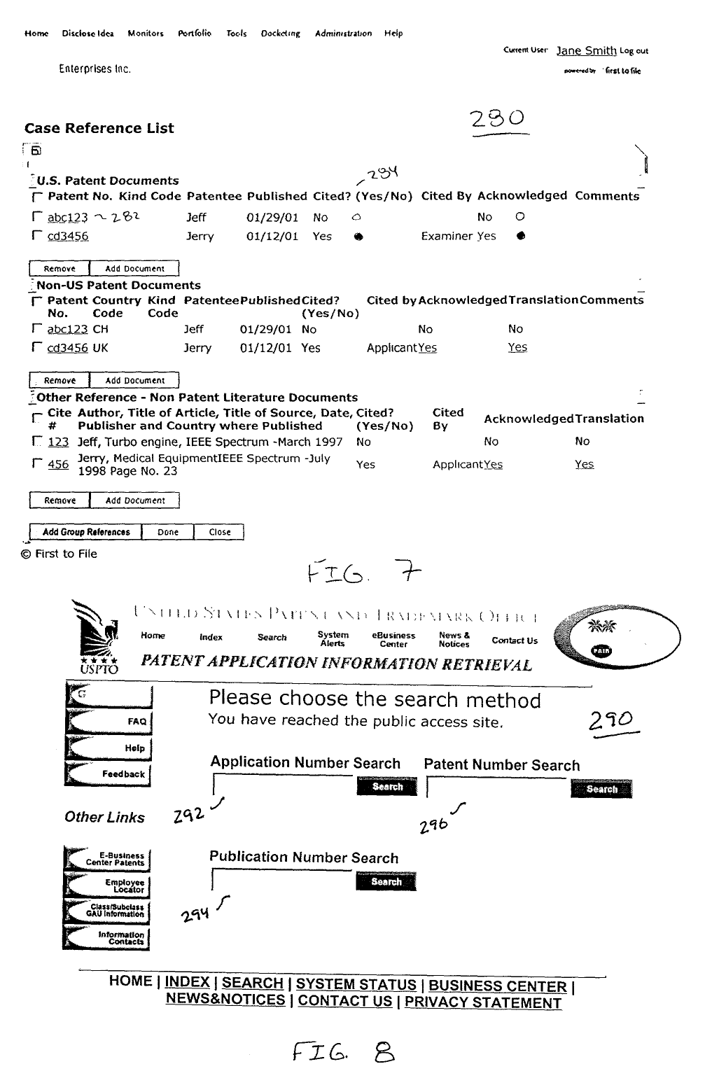

Still another feature provided in some embodiments is available by selecting a status icon, such as the “check PAIR” icon 286 shown in FIG. 5. Upon selecting icon 286, IP data processing system 100 interfaces to the USPTO's Patent Application Information Retrieval (PAIR) system to retrieve status information for the case presented in the user interface. The interface request results in a Web page similar to page 290 shown in FIG. 8 being displayed to the user. Web page 290 includes fields for entry of the patent application number, publication number and patent number to be searched in the PAIR system. IP data processing system 100 automatically populates one of these fields with appropriate data for the case that was shown in the graphical user interface from which the PAIR icon was selected. The user then simply selects the appropriate “search” icon to retrieve the desired status information.

In one embodiment, system 100 determines which of the patent number 292, publication number 294 or application number 296 fields to populate with data based on the following algorithm. If a patent for the file displayed in the user interface has already issued, patent number field 296 is populated with the patent number. If the patent application was published but a patent has not yet been granted, publication number field 294 is populated with the publication number. Finally, if an application has been filed and has received a serial number but the application has not been published and a patent has not been granted, application number field 292 is populated with the application number. Referring back to FIG. 5, in other embodiments status icon 286 can interface to other patent offices as appropriate using appropriate interface programs. For example, if Web page 250 displayed file and other links for a EPO patent application, icon 286 would interface to the European Patent Office in a manner appropriate to retrieve status for the European patent or patent application.

Another feature provided in some embodiments is available by selecting an organize icon such as icon 288. Upon selecting icon 288, a user may organize the contents included in the associated section by moving documents or files UP or down in the displayed list or grouping them in folders or packages.

Having fully described several embodiments of the present invention, other equivalent or alternative methods of practicing the invention will be apparent to those skilled in the art. For example, while the example above described graphical user interface 230 as being accessed through a “view cases” menu selection, the interface is typically accessible from any menu option where data associated with specific cases is displayed such as a portfolio views, search engine results and others. Also, while the invention was illustrated with respect to Web pages generated by a server and viewed by client systems, it can also be implemented in other computing environments including a Windows environment and others. Furthermore, while the interface was described as a “trifold interface,” in other embodiments the interface may include additional, different or fewer sections. For example, in one embodiment the interface does not include the correspondence section or the case summary section and thus includes only two sections. In another embodiment the interface includes a fifth section in which tabs are shown on the bottom or side of Web page 230. Each tab represents a particular country that the patent application was filed in. For example, if an application was filed in four separate countries: the United States, Japan, Korea and Taiwan there would be corresponding tabs for each country. The file links displayed in sections 232, 234 and 236 would then be specific for documents/files related to the application in the particular country for the selected tab. Documents associated with the prosecution of the particular patent application in the other countries can be quickly accessed by selecting the tab for that country and than the appropriate link in one of sections 232, 234 or 236. Also, the main sections of various embodiments can be panels of a window, can be different windows or can simply be different areas of a screen as shown in FIGS. 4 and 5. These and other embodiments as well as alternatives and equivalents to the invention will be recognizable to those of skill in the art after reading the description of the present invention. The scope of the invention should not, therefore, be determined solely by reference to the above description, but instead should be determined with reference to the appended claims along with their full scope of equivalents and alternatives.

What is claimed is:

1. A computer graphical user interface that provides access to information pertaining to a patent application, said graphical user interface comprising:
a first display section in which is displayed a plurality of first file links selectable by said user, each of said first file links providing access to a patent document that was filed in or sent from a patent office and that is stored on a computer-readable medium in an image file format; and
a second display section in which is displayed a plurality of second file links selectable by said user, each of said second file links providing access to a patent file that is associated with an application program and stored on a computer-readable medium;
wherein said patent documents and said patent files accessible from said first and second display sections all pertain to said patent application.

2. The graphical user interface of claim 1 wherein each of said patent files is stored on said compute-readable medium in a format native to said associated application program or convertible to said native format by said associated application program.

3. The graphical user interface of claim 1 wherein at least one of said patent files accessible through said plurality of second file links corresponds to a patent document accessible through said plurality of first file links.

4. The graphical user interface of claim 1 further comprising a third display section in which is displayed a plurality of third file links selectable by a user of the user interface, each of said third file links providing access to correspondence generated from one or more of an inventor client system, an in-house client system or an outside representative client system, wherein said correspondence is stored on a computer-readable medium and pertains to said patent application.

5. The graphical user interface of claim 4 wherein said first, second and third plurality of file links are either html hypertext links or folders.

6. The graphical user interface of claim 5 wherein each of said first, second and third sections are a panel on a Web page.

7. The graphical user interface of claim 4 wherein each of said first, second and third sections are a panel of a window in a Windows™-based environment.

8. The graphical user interface of claim 4 wherein said first, second and third display sections are displayed adjacent to each other across a width of a display.

9. The graphical user interface of claim 1 wherein said second display section also includes a plurality of fourth file links wherein each of said fourth file links provides access to a document that is a prior art reference to said patent application.

10. The graphical user interface of claim 1 wherein said first and second display sections are separate windows.

11. The graphical user interface of claim 1 wherein said first and second display sections are panels of a single window.

12. The graphical user interface of claim 1 wherein said patent documents are locked and not available to be edited.

13. A method of providing access to information pertaining to a patent application, said method comprising:
storing said information on a computer-readable medium, wherein said information includes at least (i) correspondence generated from one or more of an inventor client system, an in-house client system and an outside representative client system; (ii) patent documents filed in or sent from a patent office; and (iii) patent files associated with said patent application, wherein at least some of said patent documents are stored in an image file format and at least some of said patent files are associated with an application program;
accessing said computer-readable medium with a computer processor and using said computer processor to generate on a display at least first, second and third separate sections wherein in said first section is displayed a list of said correspondence, in said second section is displayed a list of said patent documents and in said third section is displayed a list of said patent files.

14. The method of claim 12 wherein at least some file are stored in a format native to said associated application program.

15. The method of claim 13 wherein said computer generates a fourth separate section, said fourth section including summary information related to said patent application including at least said application title and a file number.

16. The method of claim 15 wherein said fourth section further comprises an information icon that, when selected, causes additional summary information related to said patent application to be displayed.

17. The method of claim 13 wherein each of said first, second and third display sections comprises a plurality of rows with each row containing a file link selectable by a user to allow said user to view one or more of said correspondence, said patent documents or said patent files.

18. The method of claim 17 wherein each of said file links is either a hypertext link or a folder or package that contains other folders and/or hypertext links.

19. The method of claim 13 wherein said patent documents are locked and not available to be edited.

20. A computer-implemented method of providing access to information pertaining to a patent application, said method comprising:
storing said information on a computer-readable medium accessible to a server system, wherein said information includes at least (i) correspondence generated from one or more of an inventor client system, an in-house client system and an outside representative client system; (ii) patent documents filed in or sent from a patent office; and (iii) patent files associated with said patent application, wherein at least some of said patent documents are stored in an image file format and at least some of said patent files are associated with an application program;
generating a web page from said server system, said web page including at least first, second and third separate sections wherein said first section comprises file links to said correspondence, said second section comprises file links to said patent documents and said third section comprises file links to said patent files; and
viewing said web page from a client system.

21. The computer-implemented method of claim 20 wherein said at least some patent files are stored in a format native to said associated application program.

22. The method of claim 20 wherein said patent documents are locked and thereby not available to be edited by client systems.

23. The method of claim 20 wherein said patent documents are stored in a bit-mapped format.

24. The method of claim 23 wherein said patent documents stored in bit-mapped format include documents scanned from a paper document and documents generated from said patent files.

25. The method of claim 20 wherein said web page further includes a information icon, which when selected by said client system, causes a case information web page to be generated by said server system and displayed on said client system, said case information web page displaying at least a filing date and application number associated with said patent application.

26. The method of claim 25 wherein said case information web page further includes links to additional information associated with said patent application, including priority information, power of attorney information, assignment information and comments.

27. The method of claim 20 wherein said first, second and third sections are positioned side-by-side horizontally across said display.

28. The method of claim 20 wherein said first and third sections each comprise a create icon that when selected by a client system creates a document to be stored in that section, wherein at least some information in said document is populated with information that was previously associated with said patent application and stored in a database.

29. The method of claim 20 wherein each of said file links is either a hypertext link or a folder that contains other folders and/or hypertext links.

30. The method of claim 20 wherein said first and third sections each comprise an upload icon that when selected by a client system allows an electronic document to be associated with the patent application.

31. The method of claim 20 wherein at least one of said patent files corresponds to one of said patent documents.

32. A server system for managing information related to patent applications, said server system comprising:
(a) a processor;
(b) a database; and
(c) a memory for storing a computer program;
wherein said processor is operative with said computer program to:
store, in said database, information including at least (i) correspondence generated from one or more of an inventor client system, an in-house client system and an outside representative client system; (ii) patent documents filed in or sent from a patent office; and (iii) patent files associated with said patent application, wherein at least some of said patent documents are stored in an image file format and at least some of said patent files are associated with an application program; and
generate a graphical user interface that can be displayed on a display to provide access to said information, said graphical user interface including at least first, second and third separate sections wherein said first section comprises a list of said correspondence, said second section comprises a list of said patent documents and said third section comprises a list of said patent files.

33. A networked system comprising:
(a) a communication network;
(b) a client system coupled to the communication network, said client system comprising a processor and a display;
(c) a server system coupled to the communication network, said server system comprising a processor, a database, and a memory for storing a computer program;
wherein said processor is operative with said computer program to:
store, in said database, information including at least (i) correspondence generated from one or more of an inventor client system, an in-house client system and an outside representative client system; (ii) patent documents filed in or sent from a patent office; and (iii) patent files associated with said patent application, wherein at least some of said patent documents are stored in an image file format and at least some of said patent files are associated with an application program; and
generate a graphical user interface that can be displayed on said client system display to provide access to said information, said graphical user interface including at least first, second and third separate sections wherein said first section comprises a list of said correspondence, said second section comprises a list of said patent documents and said third section comprises a list of said patent files.

34. The networked system of claim 33 wherein said communication network is the Internet.
